(19) United States
(12) Patent Application Publication
(10) Pub. No.: US 2023/0256778 A1
(43) Pub. Date: Aug. 17, 2023

(54) VEHICLE TIRE LOCALIZATION SYSTEM AND METHOD USING TEMPERATURE RISE DATA

(71) Applicant: Bridgestone Americas Tire Operations, LLC, Nashville, TN (US)

(72) Inventors: Terence E. Wei, Copley, OH (US); Thomas A. Sams, Alliance, OH (US)

(21) Appl. No.: 18/016,201

(22) PCT Filed: Jul. 29, 2021
(86) PCT No.: PCT/US2021/043588

§ 371 Date: Jan. 13, 2023

Related U.S. Application Data
(60) Provisional application No. 63/073,776, filed on Sep. 2, 2020.

(51) Int. Cl. B60C 11/24; B60C 23/04

(52) U.S. Cl. CPC B60C 11/246; B60C 23/0416; B60C 23/0479

(57) ABSTRACT

A computer-implemented method for vehicle wheel position localization includes accumulating in data storage information regarding temperature characteristics corresponding to each of a respective plurality of wheel positions for each of one or more types of vehicles. The information regarding temperature characteristics may be information regarding temperature rise characteristics associated with a given load. Contained air temperature data is collected from sensors respectively associated with a tire mounted on a vehicle. The sensors may for example be TPMS sensors. A local computing unit or remote server identifies a wheel position associated with the tire, based on a comparison of the collected contained air temperature over a period of time with respect to the stored information regarding temperature characteristics. The wheel position information may be implemented to estimate and/or predict tire wear status for the corresponding tire, and optionally further to predict tire traction status further based on collected vehicle-tire data.

A portion of the disclosure of this patent document contains material that is subject to copyright protection. The copyright owner has no objection to the reproduction of the patent document or the patent disclosure, as it appears in the U.S. Pat. and Trademark Office patent file or records, but otherwise reserves all copyright rights whatsoever.

### FIELD OF THE INVENTION

The present invention relates generally to tire wear prediction and monitoring systems for wheeled vehicles. More particularly, systems, methods, and related algorithms as disclosed herein may use temperature rise data for tire localization, which may be used for fleet management, cost forecasting, and improved prediction of wear for tires of wheeled vehicles including but not limited to motorcycles, consumer vehicles (e.g., passenger and light truck), commercial and off-road (OTR) vehicles.

### BACKGROUND

Prediction of tire wear is an important tool for anyone owning or operating vehicles, particularly in the context of fleet management. As tires are used, it is normal for the tread to gradually become shallower and overall tire performance to change. At a certain point it becomes critical to be aware of the tire conditions, as insufficient tire tread can create unsafe driving conditions. For example, when road conditions are non-optimal the tires may be unable to grip the road and a driver may lose control of his or her vehicle. Generally stated, the shallower the tire tread, the more easily the driver may lose traction when driving in rain, snow, or the like.

In addition, irregular tread wear may occur for a variety of reasons that may lead users to replace a tire sooner than would otherwise have been necessary. Vehicles, drivers, and individual tires are all different from each other, and can cause tires to wear at very different rates. For instance, high performance tires for sports cars wear more quickly than touring tires for a family sedan. However, a wide variety of factors can cause a tire to wear out sooner than expected, and/or cause it to wear irregularly and create noise or vibration. Two common causes of premature and/or irregular tire wear are improper inflation pressure and out-of-spec alignment conditions.

The estimation and/or prediction of tire wear over time may typically require knowledge which tires are mounted in which wheel position for a given vehicle. However, most fleet management systems fail to sufficiently track or otherwise document such information. This creates difficulties for a number of important fleet management tasks, such as for example the generation of maintenance alerts, predicting the amount of wear life remaining, forecasting which (and when) tires will need to be replaced, cost projections, etc.

Some current techniques which exist for determining or tracking tires in corresponding wheel positions include the use of specialized devices mounted on each of the tires for that purpose. Such devices may for example emit radio signals associated with tire characteristics, or may include rotational angle sensors, etc. It would be preferable, however, to avoid additional hardware or complex software implementations for this purpose, and rather to utilize existing devices for an accurate and cost-effective solution.

### BRIEF SUMMARY

An approach as disclosed herein may accurately and reliably track the wheel positions for a given tire with respect to a given vehicle.

An exemplary embodiment of a method as disclosed herein for vehicle wheel position localization comprises accumulating in data storage information regarding temperature characteristics corresponding to each of a respective plurality of wheel positions for each of one or more types of vehicles. Contained air temperature data is collected from one or more sensors respectively associated with a tire mounted on a vehicle. A wheel position associated with the tire is then identified, based on a comparison of the collected contained air temperature over a period of time with respect to the stored information regarding temperature characteristics.

In one exemplary aspect of the above-referenced embodiment, the information regarding temperature characteristics may comprise information regarding temperature rise characteristics associated with a given load.

In another exemplary aspect of the above-referenced embodiment, the step of identifying a wheel position associated with the first tire may include identifying at least a first subset and a second subset of tires mounted on the vehicle based on comparison of respectively collected contained air temperature information against at least a first temperature characteristic signature, wherein the first tire is included in one of the at least first subset and second subset of tires. At least the one subset of tires including the first tire may further be analyzed to identify the wheel position associated with the first tire based on at least a second temperature characteristic signature.

The first temperature characteristic signature may comprise information distinguishing wheel positions according to a temperature rise signature, such as for example distinguishing drive tires based on their relatively elevated temperature rise for a given load.

The second temperature characteristic signature may comprise information distinguishing wheel positions according to steady state temperature values, such as for example distinguishing outer dual tires as being cooler relative to inner dual tires, and further distinguishing wheels associated with the front drive axle as being cooler relative to wheels associated with the rear drive axle.

In another exemplary aspect of the above-referenced embodiment, historical information is accumulated in data storage regarding tire wear for the tire, and a current tire wear status for the tire may be estimated based at least on the identified wheel position and the stored historical information regarding tire wear.

In another exemplary aspect of the above-referenced embodiment, one or more tire traction characteristics for the tire may be predicted based at least on the estimated tire wear status. The one or more predicted tire traction characteristics may be provided to an active safety unit associated with the vehicle, which accordingly modifies one or more vehicle operation settings based on at least the predicted one or more tire traction characteristics

In another exemplary aspect of the above-referenced embodiment, the historical information regarding the tire wear for the tire is updated in the data storage, based on the estimated current tire wear status.

In another exemplary aspect of the above-referenced embodiment, a tire wear status at one or more future times is predicted for the tire, based at least in part on the estimated current tire wear status.

A replacement time for the tire may further be predicted, based on one or more of the current tire wear status and the predicted tire wear status, as compared with one or more tire wear thresholds associated with the tire.

The one or more tire wear thresholds may comprise a tire tread threshold corresponding to a given wheel position associated with the tire.

In another exemplary aspect of the above-referenced embodiment, a vehicle maintenance alert comprising the predicted replacement time and an identifier for the tire may be generated, wherein a message comprising the vehicle maintenance alert is transmitted to a fleet management device.

An embodiment of a system as disclosed herein for vehicle wheel position localization may include a data storage network having stored thereon information regarding temperature characteristics corresponding to each of a respective plurality of wheel positions for each of one or more types of vehicles. For each of a plurality of vehicles, computing nodes are linked to one or more vehicle-mounted sensors respectively configured to provide contained air temperature data for one or more associated tires. A server-based computing network identifies a wheel position associated with each tire, based on a comparison of the collected contained air temperature over a period of time with respect to the stored information regarding temperature characteristics.

In one exemplary aspect of the above-referenced embodiment, the one or more vehicle-mounted sensors include one or more tire pressure monitoring system (TPMS) sensors.

### BRIEF DESCRIPTION OF THE SEVERAL VIEWS OF THE DRAWINGS

Hereinafter, embodiments of the invention are illustrated in more detail with reference to the drawings.

FIG. 1 is a block diagram representing an embodiment of a system for wheel localization and tire wear estimation as disclosed herein.

FIG. 2 is a graphical diagram representing an exemplary contained air temperature curve with respect to time.

FIG. 3 is a graphical diagram representing exemplary contained air temperature curves with respect to time, for each of a left front inner drive tire and a left rear inner drive tire for a tractor trailer type vehicle.

FIG. 4 is a graphical diagram representing exemplary contained air temperature curves with respect to time, for each of a right front inner drive tire and a right front outer drive tire for a tractor trailer type vehicle.

FIG. 5 is a flowchart representing an embodiment of a method for wheel localization and tire wear estimation as disclosed herein.

### DETAILED DESCRIPTION

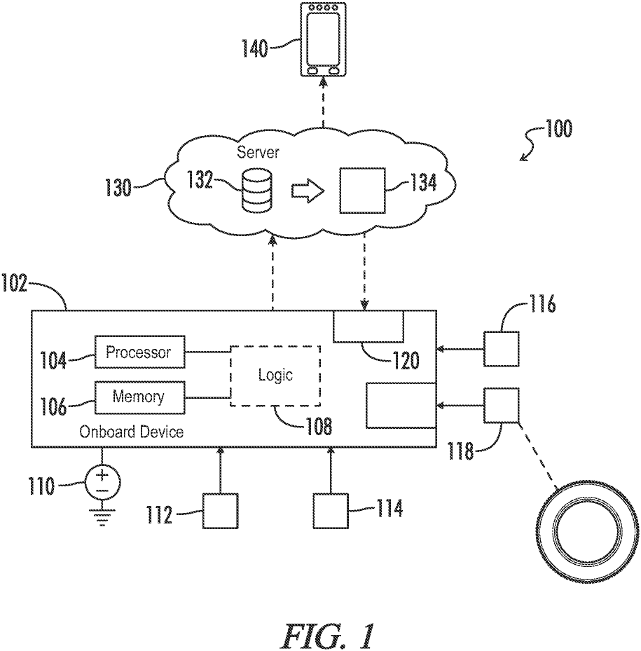

Referring generally to FIGS. 1- 5, various exemplary embodiments of an invention may now be described in detail. Where the various figures may describe embodiments sharing various common elements and features with other embodiments, similar elements and features are given the same reference numerals and redundant description thereof may be omitted below.

An exemplary invention as disclosed herein relates to the use of tire contained air temperature data for wheel localization, and optionally further for tire wear estimation and/or prediction.

Various embodiments of a system as disclosed herein may include centralized computing nodes (in e.g., a cloud server network) in functional communication with a plurality of distributed data collectors and computing nodes (e.g., associated with individual vehicles) for effectively implementing wear models as disclosed herein.

Referring initially to FIG. 1, an exemplary embodiment of the system 100 includes a computing device 102 that is onboard a vehicle and configured to at least obtain data and transmit said data to a remote server 130 and/or perform relevant computations as disclosed herein. The computing device may be portable or otherwise modular as part of a distributed vehicle data collection and control system (as shown), or otherwise may be integrally provided with respect to a central vehicle data collection control system (not shown). The device may include a processor 104 and memory 106 having program logic 108 residing thereon.

Generally stated, a system as disclosed herein may implement numerous components distributed across one or more vehicles, for example but not necessarily associated with a fleet management entity, and further a central server or server network in functional communication with each of the vehicles via a communications network. The vehicle components may typically include one or more sensors such as, e.g., vehicle body accelerometers, gyroscopes, inertial measurement units (IMU), position sensors such as global positioning system (GPS) transponders 112, tire pressure monitoring system (TPMS) sensor transmitters 118 and associated onboard receivers, or the like, as linked for example to a controller area network (CAN) bus network and providing signals thereby to local processing units. The illustrated embodiment includes for illustrative purposes, without otherwise limiting the scope of the present invention thereby, an ambient temperature sensor 116, an engine sensor 114 configured for example to provide sensed barometric pressure signals, and a DC power source 110.

In view of the following discussion, other sensors for collecting and transmitting vehicle data such as pertaining to velocity, acceleration, braking characteristics, or the like will become sufficiently apparent to one of ordinary skill in the art and are not further discussed herein. Various bus interfaces, protocols, and associated networks are well known in the art for the communication of vehicle kinetics data or the like between the respective data source and the local computing device, and one of skill in the art would recognize a wide range of such tools and means for implementing the same.

The system may include additional distributed program logic such as for example residing on a fleet management server or other user computing device 140, or a user interface of a device resident to the vehicle or associated with a driver thereof (not shown) for real-time notifications (e.g., via a visual and/or audio indicator), with the fleet management device in some embodiments being functionally linked to the onboard device via a communications network. System programming information may for example be provided on-board by the driver or from a fleet manager.

Vehicle and tire sensors may in an embodiment further be provided with unique identifiers, wherein the onboard device processor 104 can distinguish between signals provided from respective sensors on the same vehicle, and further in certain embodiments wherein a central server 130 and/or fleet maintenance supervisor client device 140 may distinguish between signals provided from tires and associated vehicle and/or tire sensors across a plurality of vehicles. In other words, sensor output values may in various embodiments be associated with a particular tire, a particular vehicle, and/or a particular tire-vehicle system for the purposes of onboard or remote/ downstream data storage and implementation for calculations as disclosed herein. The onboard device processor may communicate directly with the hosted server as shown in FIG. 1, or alternatively the driver’s mobile device or truck-mounted computing device may be configured to receive and process/transmit onboard device output data to the hosted server and/or fleet management server/device.

Signals received from a particular vehicle and/or tire sensor may be stored in onboard device memory, or an equivalent data storage unit functionally linked to the onboard device processor, for selective retrieval as needed for calculations according to the method disclosed herein. In some embodiments, raw data signals from the various signals may be communicated substantially in real time from the vehicle to the server. Alternatively, particularly in view of the inherent inefficiencies in continuous data transmission of high frequency data, the data may for example be compiled, encoded, and/or summarized for more efficient (e.g., periodic time-based or alternatively defined event-based) transmission from the vehicle to the remote server via an appropriate communications network.

The vehicle data and/or tire data, once transmitted via a communications network to the hosted server 130, may be stored for example in a database 132 associated therewith. The server may include or otherwise be associated with tire wear models and/or tire traction models 134 for selectively retrieving and processing the vehicle data and/or tire data as appropriate inputs. The models may be implemented at least in part via execution of a processor, enabling selective retrieval of the vehicle data and/or tire data and further in electronic communication for the input of any additional data or algorithms from a database, lookup table, or the like that is stored in association with the server.

Of particular relevance with respect to certain algorithms and methods as disclosed herein, as previously noted one or more sensors associated with the system may include tire pressure monitoring system (TPMS) sensors 118 as are often currently included, e.g., on certain heavy-duty trucks. An example of a conventional TPMS includes a sensor transmitter functionally linked to a TPMS receiver, itself further linked to a data processing unit. The TPMS sensor transmitter may be provided in the interior air cavity of each tire of a vehicle on either a tire wheel or an inner surface of the tire. The transmitter detects an internal pressure of the tire at a predetermined time interval, and wirelessly transmits an internal pressure value of the tire along with a unique identifier associated with the tire to the receiver. The transmitter may for example be mounted on a wheel rim so as to be integral with a tire valve. Alternatively, the transmitter may be attached to an inner surface of the tire. The receiver further relays the signals from the transmitter to the data processing unit via a communication means such as for example Bluetooth.

In addition to the inflation pressure, such TPMS sensors will also typically measure contained air temperature. The contained air temperature of a tire has a significant impact on its inflation pressure, which accordingly must be set when it is “cold”, i.e., when the tire is at ambient temperature conditions, i.e., wherein the tire casing, air in its respective cavity, and the surrounding ambient environment are all in equilibrium.

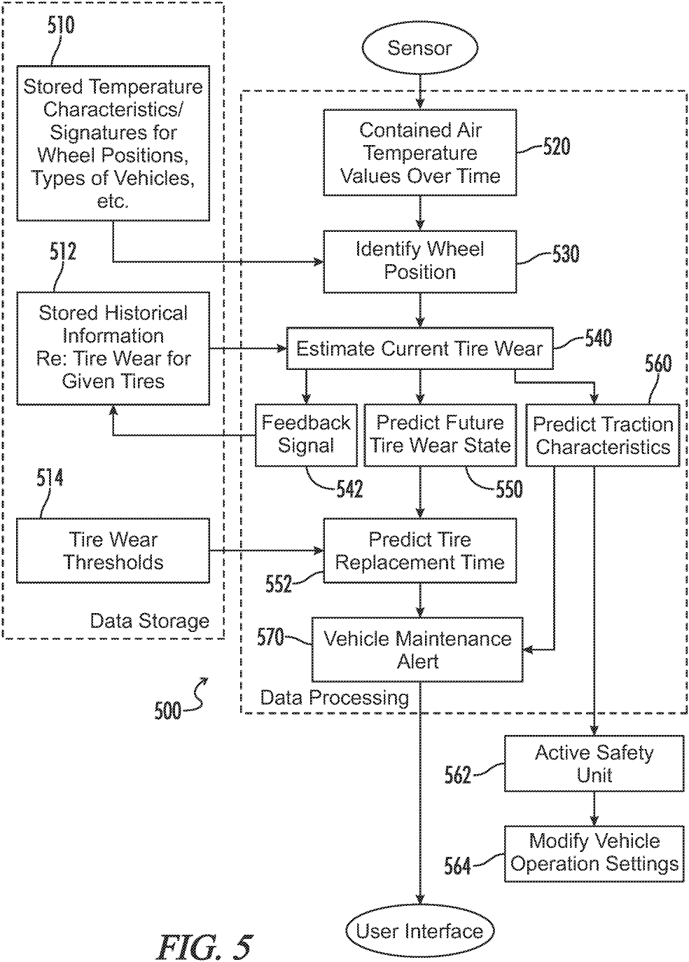

Referring next for illustrative purposes to FIG. 5, an embodiment of a method 500 as disclosed herein for vehicle wheel position localization may be described by continued and exemplary reference to FIGS. 1- 4. In a first exemplary step 510 of the method 500, information may be accumulated in data storage regarding temperature characteristics corresponding to each of a respective plurality of wheel positions for each of one or more types of vehicles. Such information may for example be accumulated over time and aggregated in data storage or acquired in bulk. The information regarding temperature characteristics may for example include information regarding temperature rise characteristics associated with a given load.

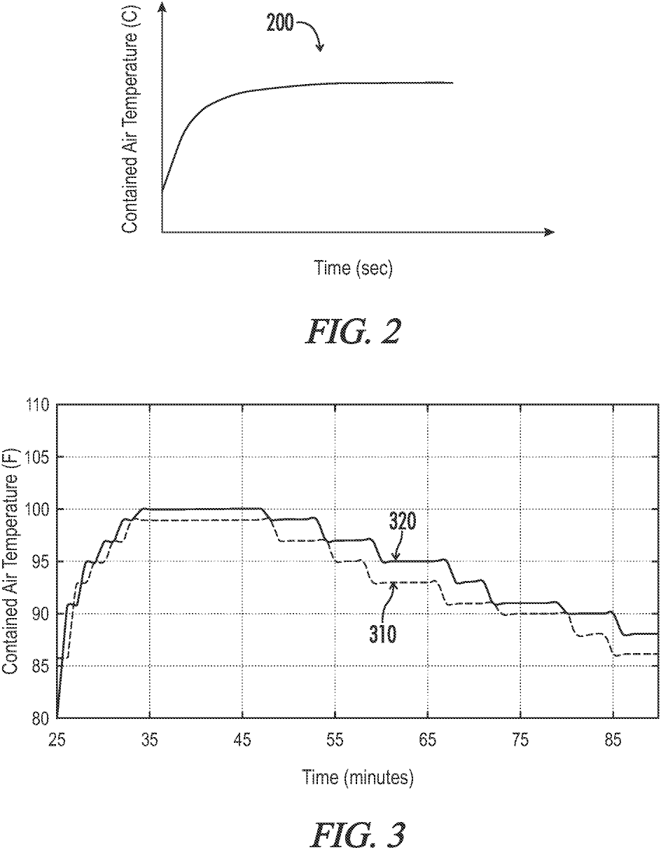

In another step 520, contained air temperature data may be collected over time from one or more sensors respectively associated with a tire mounted on a vehicle. Referring to FIG. 2, an example of TPMS contained air temperature is shown for one trip, illustrating that the temperature starts at an ambient temperature value and rises to a steady state value during the trip.

The contained air temperature is affected by several factors. Tire deflection produces heat, which causes the contained air temperature to rise. More load on the tire increases the deflection, which causes more heat to be produced, causing the contained air temperature to rise higher. Turning, braking and acceleration will also cause more tire deflection (in addition to more heat from friction between the tire and the road), causing more heat to be produced, causing the contained air temperature to rise higher.

Heat is primarily removed from the tire through convection with the air flowing around the vehicle. The amount of convection depends on the amount of airflow. For example, outer dual tires receive more airflow than inner dual tires. As another example, the front drive axle receives more airflow than the rear drive axle immediately behind.

In another exemplary step 530 of the method 500, a wheel position associated with the tire may accordingly be identified, based on a comparison of the collected contained air temperature over a period of time with respect to the stored information regarding temperature characteristics. This may for example include identifying at least a first subset and a second subset of tires mounted on the vehicle based on comparison of respectively collected contained air temperature information against at least a first temperature characteristic signature, wherein the first tire is included in one of the at least first subset and second subset of tires. At least the one subset of tires including the first tire may further be analyzed to identify the wheel position associated with the first tire based on at least a second temperature characteristic signature. In an embodiment, the first temperature characteristic signature may comprise information distinguishing wheel positions according to a temperature rise signature, such as for example distinguishing drive tires based on their relatively elevated temperature rise for a given load. In an embodiment, the second temperature characteristic signature may comprise information distinguishing wheel positions according to steady state temperature values, such as for example distinguishing outer dual tires as being cooler relative to inner dual tires, and further distinguishing wheels associated with the front drive axle as being cooler relative to wheels associated with the rear drive axle.

For a tractor trailer type truck, it is possible to use the TPMS data to identify which wheel position each sensor is in. Steer tires, drive tires, and trailer tires can be categorized by load (because all drive tires should be loaded similarly to each other) and because of temp rise characteristics (drive tires will have higher temp rise for a given load, due to the friction of driving the truck forward). Once the eight drive tires have been identified, the wheel positions can be identified using temperature differences (outer dual tires receive more airflow and will be cooler than inner dual tires, and the front drive axle receives more airflow than the rear drive axle).

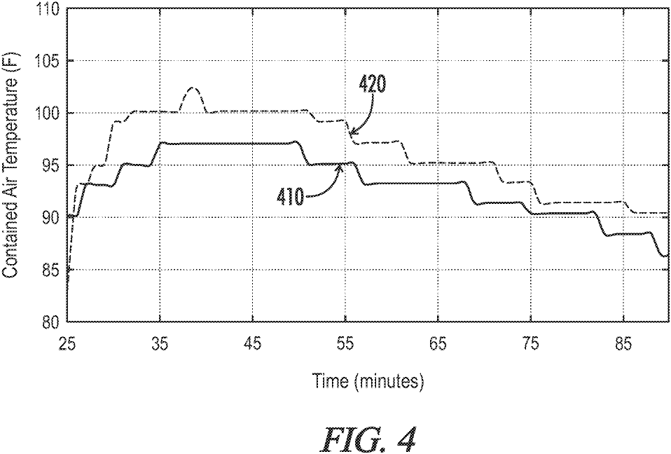

Referring next to FIGS. 3 and 4, exemplary TPMS data from a truck running at a constant load and speed demonstrates that a temperature difference is apparent between the inner and outer tires of a dual configuration, as well as the front and rear tires of tandem axle.

In FIG. 3, a left front inner drive tire 310 is plotted along with the left rear inner drive tire 320. A significant temperature difference is readily apparent between the two tires, even though they are the same specification at the same pressure and load, with the rear tire running hotter than the front tire.

FIG. 4 demonstrates exemplary results for a right front inner drive tire 420 and a right front outer drive tire 410, which again are the same specification at the same pressure and load, and also show a significant temperature difference between the two tires, with the inner tire running hotter than the outer tire.

In another step 540 of the method 500, a current tire wear status for the tire may be estimated based at least in part on the identified wheel position. In an embodiment, the current tire wear status may for example be further estimated based on historical information that has been accumulated in data storage (step 512) regarding tire wear for the tire.

Various tire wear values may be estimated based on, e.g., “digital twin” virtual representations of various physical parts, processes or systems wherein digital and physical data is paired and combined with learning systems such as for example neural networks. For example, real data from a vehicle and associated location/ route information may be provided to generate a digital representation of the vehicle tire for estimation of tire wear, wherein subsequent comparison of the estimated tire wear with a determined actual tire wear may be implemented as feedback for the machine learning algorithms. The wear model may be implemented at the vehicle, for processing via the onboard system, or the tire data and/or vehicle data may be processed to provide representative data to the hosted server for remote wear estimation.

In an embodiment, another step 542 of the method 500 may include providing feedback signals wherein the historical information regarding the tire wear for the tire is updated in the data storage, based on the estimated current tire wear status.

In an embodiment, another step 560 of the method 500 may for example include providing the tire wear status (e.g., tread depth) along with certain vehicle data as inputs to a traction model, which may be configured to provide an estimated traction status or one or more traction characteristics for the respective tire. As with the aforementioned wear model, the traction model may comprise “digital twin” virtual representations of physical parts, processes or systems wherein digital and physical data are paired and combined with learning systems such as for example artificial neural networks. Real vehicle data and/or tire data from a particular tire, vehicle or tire-vehicle system may be provided throughout the life cycle of the respective asset to generate a virtual representation of the vehicle tire for estimation of tire traction, wherein subsequent comparison of the estimated tire traction with a corresponding measured or determined actual tire traction may preferably be implemented as feedback for machine learning algorithms executed at the server level.

The traction model may in various embodiments utilize the results from prior testing, including for example stopping distance testing results, tire traction testing results, etc., as collected with respect to numerous tire-vehicle systems and associated combinations of values for input parameters (e.g., tire tread, inflation pressure, road surface characteristics, vehicle speed and acceleration, slip rate and angle, normal force, braking pressure and load), wherein a tire traction output may be effectively predicted for a given set of current vehicle data and tire data inputs.

In one embodiment, outputs from this traction model may be incorporated into an active safety system, for example in step 562 of the illustrated method 500. The term “active safety systems” as used herein may preferably encompass such systems as are generally known to one of skill in the art, including but not limited to examples such as collision avoidance systems, advanced driver-assistance systems (ADAS), anti-lock braking systems (ABS), etc., which can be configured to utilize the traction model output information to achieve optimal performance by for example modifying one or more vehicle operation settings (step 564). For example, collision avoidance systems are typically configured to take evasive action, such as automatically engaging the brakes of a host vehicle to avoid or mitigate a potential collision with a target vehicle, and enhanced information regarding the traction capabilities of the tires and accordingly the braking capabilities of the tire-vehicle system are eminently desirable.

In another embodiment, a ride-sharing autonomous fleet could use output data from the traction model to disable or otherwise selectively remove vehicles with low tread depth from use during inclement weather, or potentially to limit their maximum speeds.

In an embodiment, a step 550 of the method 500 may include predicting a tire wear status at one or more future times for the tire, based at least in part on the estimated current tire wear status.

In various embodiments, another step 552 of the method 500 may further involve comparing a current wear value and/or predicted wear values at one or more future times with respect to respective threshold values (which may be retrieved from data storage in an exemplary step 554) to determine whether (or when) the tire requires replacement. In an embodiment, a vehicle maintenance alert comprising the predicted replacement time and an identifier for the tire may be generated in step 570, wherein a message comprising the vehicle maintenance alert is transmitted to a fleet management device.

As represented for example in FIG. 1, a feedback signal corresponding to the predicted tire wear status (e.g., predicted tread depth at a given distance, time, or the like) may be provided via an interface 120 to an onboard device 102 associated with the vehicle itself, or to a mobile device 140 associated with a user, such as for example integrating with a user interface configured to provide alerts or notice/ recommendations that a tire should or soon will need to be replaced.

As another example, an autonomous vehicle fleet may comprise numerous vehicles having varying minimum tread status values, wherein the fleet management system may be configured to disable deployment of vehicles falling below a minimum threshold. The fleet management system may further implement varying minimum tread status values corresponding to wheel positions. The system may accordingly be configured to act upon a minimum tire tread value for each of a plurality of tires associated with a vehicle, or in an embodiment may calculate an aggregated tread status for the plurality of tires for comparison against a minimum threshold.

In various embodiments the method may further include data streaming even where threshold violations are not detected, wherein estimated and/or predicted wear values can be displayed in real-time on the local user interface and/or a remote display (e.g., associated with the fleet management server), and further displayed data may include, e.g., the contained air temperature.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/ storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Whereas certain preferred embodiments of the present invention may typically be described herein with respect to tire wear estimation for fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire wear and potential disabling, replacement, or intervention in the form of for example direct vehicle control adjustments.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this invention except as set forth in the following claims.

1-20. (canceled)

21. A computer-implemented method for vehicle wheel position localization, the method comprising:
accumulating in data storage information regarding temperature characteristics corresponding to each of a respective plurality of wheel positions for each of one or more types of vehicles;
collecting contained air temperature data from one or more sensors respectively associated with at least a first tire mounted on a vehicle;
identifying a wheel position associated with the first tire, based on a comparison of the collected contained air temperature over a period of time with respect to the stored information regarding temperature characteristics.

22. The computer-implemented method of claim 21, wherein the information regarding temperature characteristics comprises information regarding temperature rise characteristics associated with a given load.

23. The computer-implemented method of claim 22, wherein the step of identifying a wheel position associated with the first tire comprises:
identifying at least a first subset and a second subset of tires mounted on the vehicle based on comparison of respectively collected contained air temperature information against at least a first temperature characteristic signature, wherein the first tire is included in one of the at least first subset and second subset of tires; and
analyzing at least the one subset of tires including the first tire to identify the wheel position associated with the first tire based on at least a second temperature characteristic signature.

24. The computer-implemented method of claim 23, wherein the first temperature characteristic signature comprises information distinguishing wheel positions according to a temperature rise time, and the second temperature characteristic signature comprises information distinguishing wheel positions according to steady state temperature values.

25. The computer-implemented method of claim 21, further comprising:
accumulating in data storage historical information regarding tire wear for the first tire; and
estimating a current tire wear status for the first tire, based at least on the identified wheel position and the stored historical information regarding tire wear.

26. The computer-implemented method of claim 25, further comprising:
predicting one or more tire traction characteristics for the first tire, based at least on the estimated tire wear status;
providing the one or more predicted tire traction characteristics to an active safety unit associated with the vehicle; and
via the active safety unit, modifying one or more vehicle operation settings based on at least the predicted one or more tire traction characteristics.

27. The computer-implemented method of claim 25, further comprising updating the historical information regarding the tire wear for the first tire in the data storage, based on the estimated current tire wear status.

28. The computer-implemented method of claim 25, further comprising:
predicting a tire wear status at one or more future times for the first tire, based at least in part on the estimated current tire wear status.

29. The computer-implemented method of claim 28, further comprising:
predicting a replacement time for the first tire, based on one or more of the current tire wear status and the predicted tire wear status, as compared with one or more tire wear thresholds associated with the first tire.

30. The computer-implemented method of claim 29, wherein the one or more tire wear thresholds comprise a tire tread threshold corresponding to a given wheel position associated with the first tire.

31. The computer-implemented method of claim 29, further comprising:
generating a vehicle maintenance alert comprising the predicted replacement time and an identifier for the first tire; and
transmitting a message comprising the vehicle maintenance alert to a fleet management device.

32. A system for vehicle wheel position localization, comprising:
a data storage network having stored thereon information regarding temperature characteristics corresponding to each of a respective plurality of wheel positions for each of one or more types of vehicles;
for each of a plurality of vehicles, at least one computing node linked to one or more vehicle-mounted sensors respectively configured to provide contained air temperature data for one or more associated tires;
a server-based computing network comprising computer readable media having instructions residing thereon and executable by one or more processors, the server network configured to identify a wheel position associated with each tire, based on a comparison of the collected contained air temperature over a period of time with respect to the stored information regarding temperature characteristics.

33. The system of claim 32, wherein the one or more vehicle-mounted sensors include at least a tire pressure monitoring system (TPMS) sensor.

34. The system of claim 32, wherein the information regarding temperature characteristics comprises information regarding temperature rise characteristics associated with a given load.

35. The system of claim 34, wherein the server network is configured to identify a wheel position associated with each tire on a given vehicle by:
identifying at least a first subset and a second subset of tires mounted on the given vehicle based on comparison of respectively collected contained air temperature information against at least a first temperature characteristic signature; and
analyzing the at least first subset and second subset of tires to identify the wheel positions associated each associated tire based on at least a second temperature characteristic signature.

36. The system of claim 35, wherein the first temperature characteristic signature comprises information distinguishing wheel positions according to a temperature rise time, and the second temperature characteristic signature comprises information distinguishing wheel positions according to steady state temperature values.

37. The system of claim 32, wherein:
the data storage network further comprises historical information regarding tire wear for a given tire; and
the server network is further configured to estimate a current tire wear status for the given tire, based at least on the identified wheel position and the stored historical information regarding tire wear.

38. The system of claim 37, wherein the server network is further configured to:
predict one or more tire traction characteristics for the given tire, based at least on the estimated tire wear status; and
provide the one or more predicted tire traction characteristics to an active safety unit for the vehicle associated with the given tire;
wherein the active safety unit is configured to modify one or more vehicle operation settings based on at least the predicted one or more tire traction characteristics.

39. The system of claim 37, wherein the server network is further configured to:
predict a tire wear status at one or more future times for the given tire, based at least in part on the estimated current tire wear status; and
predict a replacement time for the given tire, based on one or more of the current tire wear status and the predicted tire wear status, as compared with one or more tire wear thresholds associated with the given tire.

40. The system of claim 39, wherein the one or more tire wear thresholds comprise a tire tread threshold corresponding to a given wheel position.
